(19) United States
(12) Patent Application Publication
(10) Pub. No.: US 2019/0384276 A1
(43) Pub. Date: Dec. 19, 2019

(54) DRONE ASSISTED NAVIGATION SYSTEM FOR A VEHICLE

(71) Applicant: Delphi Technologies, LLC, Troy, MI (US)

(72) Inventor: Yimu Wang, Pittsburgh, PA (US)

(21) Appl. No.: 16/006,950

(22) Filed: Jun. 13, 2018

(51) Int. Cl. G05D 1/00; G01C 21/20; G01C 21/28; G05D 1/08; G05D 1/02

(52) U.S. Cl. CPC G05D 1/0022; G01C 21/20; G01C 21/28; G05D 2201/0213; G05D 1/0212; G05D 1/0231; G05D 1/0257; G05D 1/0808

(57) ABSTRACT

A includes a vehicle and a drone. The vehicle includes a sensor system, a navigation system, a map, and a receiver. The sensor system provides vehicle location data to the navigation system that locates the vehicle on a roadway represented by the map. The sensor system includes one or more of a computer vision system, a radar system, and a LIDAR system. The drone includes a transmitter and at least one position-tracking device configured to determine drone location data. Drone use is initiated from the vehicle in accordance with a determination by the processor that the vehicle location data provided by the sensor system is insufficient for the navigation system to navigate the vehicle. The transmitter is configured to transmit the drone location data to the receiver.

### TECHNICAL FIELD

The present disclosure relates to autonomous vehicles, and more particularly, to an intent communication system for an autonomous vehicle.

### SUMMARY

A system according to one, non-limiting, embodiment of the present disclosure includes a vehicle and a drone. The vehicle includes one or more sensor systems, one or more navigation systems, one or more maps, and a receiver. The one or more sensor systems provide vehicle location data to the one or more navigation systems locating the vehicle on a roadway represented by the one or more maps. The one or more sensor systems include one or more of a computer vision system, a radar system, and a LIDAR system. The drone includes a transmitter and at least one position-tracking device configured to determine drone location data. Use of the drone is initiated from the vehicle in accordance with a determination by the one or more processors that the vehicle location data provided by the one or more sensor systems is insufficient for the one or more navigation systems to navigate the vehicle. The transmitter is configured to transmit the drone location data to the receiver.

A vehicle system according to another, non-limiting, embodiment includes one or more navigation systems, one or more sensor systems, and one or more processors. The one or more navigation systems are configured to effect vehicle maneuvers. The one or more sensor systems are configured to generate vehicle location data, and include at least one or more of a computer-vision system, a radar system, and a LIDAR system. The one or more processors are configured to receive the vehicle location data, determine if the vehicle location data is insufficient for the one or more navigation systems to effect the vehicle maneuvers, and if insufficient, to utilize drone location data to effect the vehicle maneuvers.

A method of operating the system according to another, non-limiting, embodiment includes the step of receiving vehicle location data from one or more sensor systems of a vehicle. One or more processors then determine that the vehicle location data is insufficient to locate the vehicle on a roadway. As a result, a drone may be deployed. After drone deployment, the one or more processors may then receive drone location data from the drone. The drone location data is then processed by the one or more processors. Via the processing of the drone location data, the one or more processors may then determine a location of the vehicle on the roadway.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of a system according to one, non-limiting exemplary embodiment of the present disclosure, applied to a mountainous scene and roadway;

FIG. 2 is a schematic of the system; and

FIG. 3 is a flowchart of a method of operating the system.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

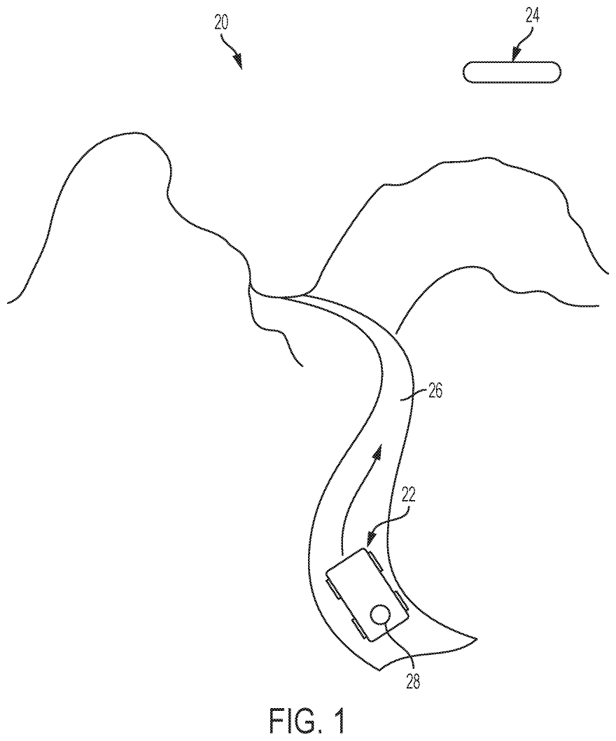

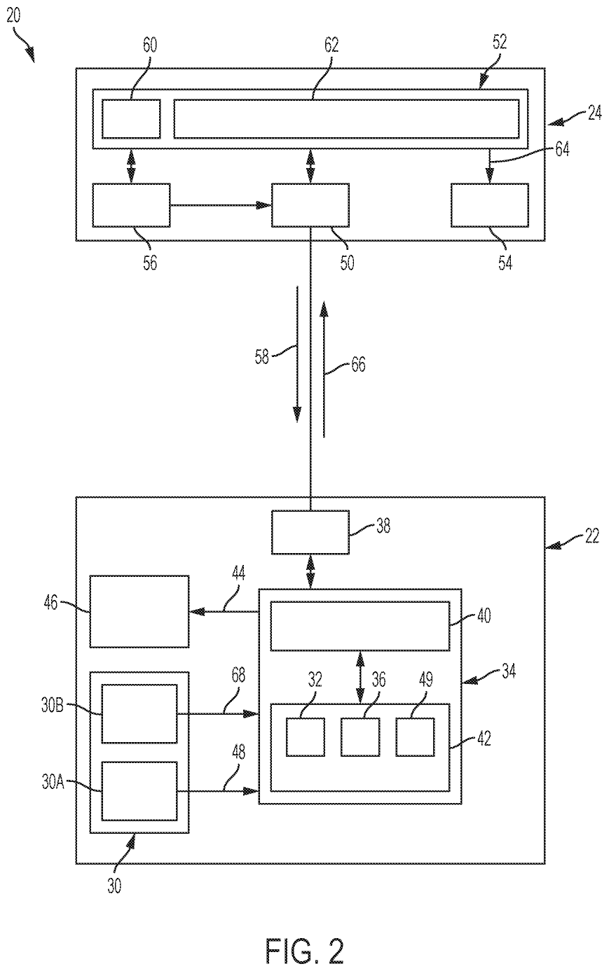

Referring to FIG. 1, a system 20 includes a vehicle 22 and a drone 24 configured to assist in navigation of the vehicle 22 over a wireless pathway 23 (see FIG. 2). In one embodiment, the vehicle 22 is an autonomous vehicle and is adapted to move upon a roadway 26, and the drone 24, is an aerial drone. In one example and as illustrated, the drone 24 may be constructed to depart and land upon a landing pad 28 carried by the vehicle 22, and provides navigation assistance only to the vehicle 22. In another example, the drone 24 may be a communal drone adapted to provide navigation services to a plurality of vehicles within a communication range, and as requested by the vehicles. In another embodiment, the system 20 may only include the vehicle component, or alternatively, the drone component. Although the vehicle 22 is illustrated as a vehicle on the roadway 26, other examples of the vehicle 22 may include aircraft, marine vessels, off-road vehicles, and others.

Referring to FIGS. 1 and 2, and in one embodiment, the vehicle 22 includes one or more sensor systems 30 (e.g., two illustrated in FIG. 2 as 30A and 30B), one or more navigation systems 32, one or more controller-circuits 34, one or more maps 36, and a communication device 38. In one embodiment, the communication device 38 may be a receiver adapted to receive communications from the drone 24. In another embodiment, the communication device 38 may be a transceiver (i.e., bidirectional communication device) adapted to both transmit and receive communications to and from the drone 24.

The controller-circuit(s) 34 of the vehicle 22 include one or more processors 40 and one or more electronic storage mediums 42. The processor 40 is any combination of one or more of a central processing unit (CPU), multiprocessor, microcontroller unit (MCU), digital signal processor (DSP), application specific integrated circuit, and others capable of executing software instructions or otherwise controllable to behave according to predetermined logic. The storage medium 42 is, optionally, any combination of read and write memory (RAM) and read only memory (ROM). The storage medium 42 may also include persistent storage, which can be any single one or combination of solid state memory, magnetic memory, or optical memory storing a computer program (i.e., application) with software instructions.

In one embodiment, the vehicle 22 is an autonomous vehicle, and the controller-circuit 34 of the vehicle 22 is configured to output an array of operating commands (see arrows 44) based in-part on the navigation system 32. The operating commands 44 are received by one or more actuation devices 46 (e.g., vehicle maneuver devices) adapted to control various maneuvers of the vehicle 22. Examples of the actuation devices 46 include one or more of a steering actuator, a brake actuator, an acceleration actuator, and others generally known in the art of autonomous vehicles.

The sensor system 30 is configured to provide location data (see arrow 48 in FIG. 2) to the navigation system 32 for locating the vehicle 22 upon the roadway 26. In one embodiment, the roadway 26 is represented by the map 36 stored in the electronic storage medium 42 of the controller-circuit 34. In one embodiment, the navigation system 32 is at least in-part a software-based application executed by the processor 40 of the controller-circuit 34. The location data 48 is at least used when communication with the drone 24 is not needed (i.e., normal operation). Non-limiting examples of the sensor system 30 include one or more of a satellite-based navigation system (e.g., GPS), a computer vision system, a radar system, a light detection and ranging (LIDAR) system, and a land-based system (e.g., beacon stations).

The map 36 is preprogrammed into the storage medium 42 for use by the navigation system 32. The navigation system 32 is configured to determine routes that the vehicle 22 will travel. The available routes are constrained by roadways represented by the preprogrammed map 36. During normal operation, the navigation system 32 receives the location data 48 from the sensor system 30 to determine and track the present location of the vehicle. To determine an upcoming vehicle route, the navigation system 32 then applies the current location to the preprogrammed map 36. In the example of an autonomous vehicle, the controller-circuit 34 of the vehicle 22 then sends the appropriate command signals 44 to the actuation device(s) 46 to effect vehicle maneuvers that follow the determined vehicle route. In a scenario where the controller-circuit 34 of the vehicle 22 determines that the location data 48 is insufficient for the navigation system 32 to navigate the vehicle 22, the system 20 may then invoke use of the drone 24.

In one embodiment, the navigation system 32 is configured to determine that the location data 48 is insufficient by comparing the localization information contained as part of the location data 48 to a predetermined threshold 49. The threshold 49 is preprogrammed into, and stored by, the storage medium 42 of the controller-circuit 34. In one embodiment, this localization is associated with a distance that is greater than the predetermined threshold 49 of an expected localization. Examples of the expected localization include an expected localization based on a previous localization and a known path, and an expected localization based on a previous localization and a known speed of the vehicle 22, or an expected localization based on a previous localization and both of a known path and a known speed. In one embodiment, the predetermined threshold 49 may be a matrix of values dependent upon (i.e., a function of) a previous localization value and a known path and/or a present speed of the vehicle 22. As will be appreciated, the accuracy of a localization, and by extension, the threshold of expected accuracy can be dependent on the previous path and speed of the vehicle, (e.g., if the vehicle is passing into an urban canyon or is moving slowly).

In one embodiment, the drone 24 of the system 20 includes a communication device 50, at least one controller-circuit 52, an actuator device 54 (i e , maneuver device), at least one position-tracking device 56 configured to generate drone location data (see arrow 58 in FIG. 2). In one embodiment, the communication device 46 may be a transmitter adapted to transmit the drone location data 58 to the vehicle 22 for receipt by the controller-circuit 34 of the vehicle 22. In another embodiment, the communication device 46 may be a transceiver (i.e., bidirectional communication device) adapted to both transmit and receive communications to and from the vehicle 22. Non-limiting examples of the position-tracking device 56 include one or more of a satellite-based navigation system (e.g., GPS), a computer vision system, radar, and a LIDAR system.

The controller-circuit(s) 52 of the drone 24 include one or more processors 60 and one or more electronic storage mediums 62. The processor 60 is any combination of one or more of a central processing unit (CPU), multiprocessor, microcontroller unit (MCU), digital signal processor (DSP), application specific integrated circuit, and others capable of executing software instructions or otherwise controllable to behave according to predetermined logic. The storage medium 62 is, optionally, any combination of read and write memory (RAM) and read only memory (ROM). The storage medium 62 may also include persistent storage, which can be any single one or combination of solid state memory, magnetic memory, or optical memory storing a computer program (i.e., application) with software instructions.

In one embodiment, the controller-circuit 52 of the drone 24 is configured to output at least one operating command signal (see arrow 64) based at least in-part on a command signal (see arrow 66) from the controller-circuit 34 of the vehicle 22. Moe specifically, the processor 40 of the vehicle controller-circuitry 34 generates the command signal 66. The vehicle communication device 38 then wirelessly send the signal 66 to the drone communication device 50 for receipt by the drone controller-circuitry 52 for generation of the operating command signal(s) 64. The operating command signal(s) 64 are then received by at least one of the actuator devices 54 adapted to maneuver the drone 24.

In one embodiment, the drone location data 58 generated by the position-tracking device 56 of the drone 24 includes tracking data established with respect to the vehicle 22 (i.e., three-dimensional orientation between the vehicle 22 and the drone 24), and geographic position data associated with the geographic position of the drone itself. For example, the tracking device 56 may include the LIDAR system to generate the tracking data of the drone location data 58, and the GPS to generate the geographic position data of the drone location data 58. When the vehicle location data 48 is deemed insufficient by the controller-circuit 34 of the vehicle 22, the navigation system 32 uses both the tracking data and the geographic position data of the drone location data 58 to navigate the vehicle 22. In another embodiment, the controller-circuit 52 of the drone 24 is configured to process the tracking data and the geographic position data of the drone location data 58 for the vehicle 22, and thereby provide the vehicle with a vehicle geographic position (i.e., a substitute for the vehicle location data 48). This embodiment is particularly advantageous where the drone 24 is a communal drone that services a plurality of the vehicles.

In furtherance of this embodiment, and in one example, the controller-circuit 52 of the drone 24 may also utilize, at least in-part, the tracking data of the drone location data 58 to generate the drone operating command signals 64, and thereby control flight patterns of the drone 24 with respect to the vehicle 22. This example is particularly advantageous where the drone 24 is specific to the vehicle 22.

In another example, a sensor system 30B of the vehicle sensor systems 30 may be utilized to track the drone 24 (i.e., instead of the drone tracking the vehicle). For instance, and in one scenario, if a GPS 30A of the vehicle sensor systems 30 loses reliable communication with various satellites, another sensor system 30B (e.g., LIDAR system) of the sensor systems 30 is utilized to track the drone 24 by generating tracking data (see arrow 68 in FIG. 2). In this example, the tracking data 68 may be received by the navigation system 32, along with the geographic position data of the drone location data 58, to navigate the vehicle 22. It is contemplated that the tracking device 56 of the drone 24 in this example may only include a GPS to generate the geographic position data, and that the command signals 66 (i.e., drone maneuver commands) sent to the drone 24 from the vehicle control-circuitry 34 include flight control, or maneuvering commands, based at least in-part on the tracking data 68.

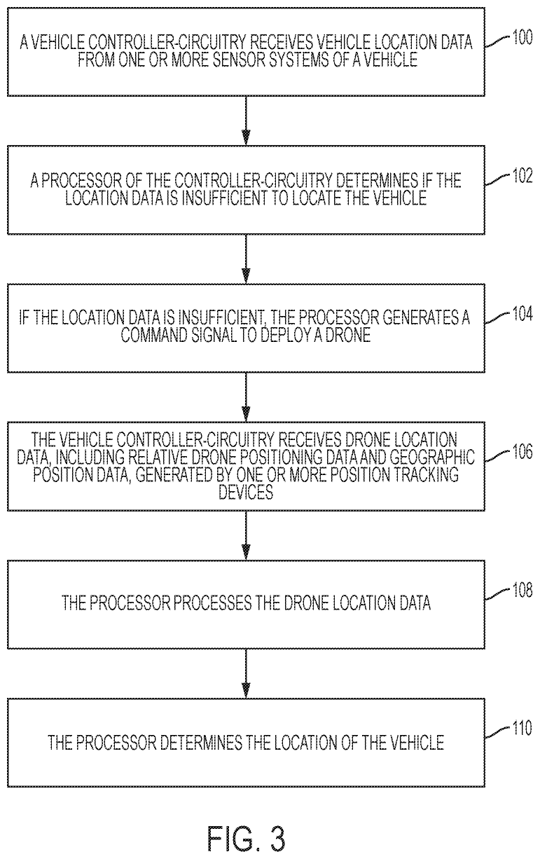

Referring to FIG. 3, one embodiment of a method of operating the system 20 is illustrated. At block 100, the vehicle controller-circuitry 34 receives vehicle location data 68 from the one or more sensor systems 30 of the vehicle 22. At block 102, the processor 40 of the controller-circuitry 34 determines the location data 68 is insufficient to locate the vehicle 22 on the roadway 26. At block 104, and upon this determination, the processor 40 generates a command signal 66 to deploy the drone 24.

At block 106, the vehicle controller-circuitry 34 receives drone location data 58 from the deployed drone. The drone location data includes a relative drone positioning data associated with a position of the drone 24 relative to the vehicle 22, and geographic position data of the drone 24, both generated by one or more position-tracking devices 56 disposed in the drone 24. At block 108, the processor 40 processes the drone location data 58. At block 110, the processor 40 (i.e., via the navigation system 32) determines the location of the vehicle 22 on the roadway 26.

The various functions described above may be implemented or supported by a computer program that is formed from computer readable program codes, and that is embodied in a non-transitory computer readable medium. Computer readable program codes may include source codes, object codes, executable codes, and others. Computer readable mediums may be any type of media capable of being accessed by a computer, and may include Read Only Memory (ROM), Random Access Memory (RAM), a hard disk drive, a compact disc (CD), a digital video disc (DVD), or other non-transitory forms.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, die term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms used herein such as component, application, module, system, and the like are intended to refer to a computer-related entity, either hardware, a combination of hardware and software, or software execution. By way of example, an application may be, but is not limited to, a process running on a processor, a processor, an object, an executable, a thread of execution, a program, and/or a computer. An application running on a server and the server, may be a component. One or more applications may reside within a process and/or thread of execution and an application may be localized on one computer and/or distributed between two or more computers.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A system comprising:
a vehicle including one or more sensor systems, one or more navigation systems, one or more maps, and a receiver, the one or more sensor systems providing vehicle location data to the one or more navigation systems locating the vehicle on a roadway represented by the one or more maps, the one or more sensor systems including one or more of a computer vision system, a radar system, and a LIDAR system; and
a drone including a transmitter and at least one position-tracking device configured to determine drone location data, drone use initiated from the vehicle in accordance with a determination by the one or more processors that the vehicle location data provided by the one or more sensor systems is insufficient for the one or more navigation systems to navigate the vehicle, wherein the transmitter is configured to transmit the drone location data to the receiver.

2. The system set forth in claim 1, further comprising:
the one or more navigation systems using data from the one or more sensor systems to determine one or more routes for the vehicle.

3. The system set forth in claim 2, wherein the routes are constrained by roadways represented by the one or more maps.

4. The system set forth in claim 3, wherein the one or more processors communicate with the one or more controllers of the vehicle to maneuver the vehicle on the one or more routes.

5. The system set forth in claim 1, wherein the vehicle is land-based and the drone is an aerial drone.

6. The system set forth in claim 5, wherein the aerial drone is a communal drone adapted to broadcast drone location data to a plurality of vehicles.

7. The system set forth in claim 1, wherein the receiver is a transceiver.

8. The system set forth in claim 7, wherein transmitter is a transceiver.

9. The system set forth in claim 8, wherein the one or more processors are configured to determine drone maneuver commands and the transceiver of the drone is configured to receive the drone maneuver commands from the transceiver of the vehicle, and input the drone maneuver commands to at least one processor of the drone to effect drone maneuvers.

10. The system set forth in claim 9, wherein the drone maneuver commands include drone deployment from the vehicle.

11. The system set forth in claim 1, wherein the one or more sensor systems include at least one of a satellite-based system and a land-based system.

12. The system set forth in claim 1, wherein the determination that the vehicle location data is insufficient is based on a localization that is greater than a predetermined threshold.

13. The system set forth in claim 12, wherein the localization is associated with a distance greater than the predetermined threshold of an expected localization.

14. The system set forth in claim 13, wherein the expected localization is based on a previous localization and a known path.

15. The system set forth in claim 13, wherein the expected localization is based on a previous localization and a known speed.

16. The system set forth in claim 1, wherein the position-tracking device includes one or more of a computer vision system, a radar system, and a LIDAR system.

17. The system set forth in claim 1, wherein the at least one processor is configured to utilize the drone location data to determine a position of the vehicle.

18. The system set forth in claim 17, wherein the drone location data includes geographic position data of the drone and relative drone positioning data with respect to the vehicle and both generated by the at least one position tracking device.

19. The system set forth in claim 17, wherein the drone location data includes geographic position data, the at least one position tracking device includes a satellite-based system, the one or more sensor systems of the vehicle are configured to track the drone and output relative drone positioning data, and the at least one processor is configured to utilize the drone location data and the relative drone position data to determine a position of the vehicle.

20. A vehicle system comprising:
one or more navigation systems configured to effect vehicle maneuvers;
one or more sensor systems configured to generate vehicle location data and including at least one or more of a computer-vision system, a radar system, and a LIDAR system; and
one or more processors configured to receive the vehicle location data, determine if the vehicle location data is insufficient for the one or more navigation systems to effect the vehicle maneuvers, and if insufficient, to utilize drone location data to effect the vehicle maneuvers.

21. The vehicle system set forth in claim 20, further comprising:
a receiver adapted to receive the drone location data and send to the one or more processors.

22. The vehicle system set forth in claim 21, wherein the drone location data includes drone geographic position data and relative drone positioning data indicative of positioning between a land-based vehicle utilizing the vehicle system and an aerial-drone.

23. The vehicle system set forth in claim 21, wherein the at least one sensor system is configured to generate relative drone positioning data indicative of positioning between a land-based vehicle utilizing the vehicle system and an aerial-drone, and the relative drone positioning data is utilized by the at least one processor when the vehicle location data is insufficient.

24. The vehicle system set forth in claim 21, wherein the receiver is a transceiver and the one or more processors are configured to determine drone maneuver commands and transmit the commands via the transceiver.

25. The vehicle system set forth in claim 24, wherein the drone maneuver commands include drone deployment.

26. The vehicle system set forth in claim 20, wherein the one or more sensor systems include at least one of a satellite-based system and a land-based system.

27. The vehicle system set forth in claim 20, wherein the determination that the vehicle location data is insufficient is based on a localization that is greater than a predetermined threshold.

28. The vehicle system set forth in claim 27, wherein the localization is associated with a distance greater than the predetermined threshold of an expected localization.

29. The vehicle system set forth in claim 28, wherein the expected localization is based on a previous localization and a known path.

30. The vehicle system set forth in claim 28, wherein the expected localization is based on a previous localization and a known speed.

31. A method comprising:
receiving vehicle location data from one or more sensor systems of a vehicle;
determining by one or more processors that the vehicle location data is insufficient to locate the vehicle on a roadway;
deploying a drone;
receiving drone location data from the drone;
processing the drone location data by the one or more processors; and
determining a location of the vehicle on the roadway.

32. The method set forth in claim 31, wherein the drone location data includes relative drone positioning data associated with a position of the drone relative to the vehicle and geographic position data of the drone, both generated by one or more position-tracking devices disposed in the drone.
